(19) United States
(12) Patent Application Publication
(10) Pub. No.: US 2006/0069596 A1
(43) Pub. Date: Mar. 30, 2006

(54) Workflow hosting computing system using a collaborative application

(75) Inventors: George F. Hatoun, Redmond, WA (US); Jon F. Matousek, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/117,808

(22) Filed: Apr. 29, 2005

Related U.S. Application Data
(60) Provisional application No. 60/614,096, filed on Sep. 29, 2004.

(51) Int. Cl. G06F 17/60

(52) U.S. Cl. 705/7

(57) ABSTRACT

A workflow hosting collaborative application computing system is disclosed. The workflow hosting collaborative application computing system comprises a collaborative application able to support workflow services; workflow services supported by the collaborative application including a virtual workflow operating system and workflow management tools; one or more application programs for communicating with the collaborative application; and one or more workflow authoring tools for creating workflows. The workflow operating system includes a workflow engine for instantiating and executing instances of workflows created using the authoring tools. The workflow engine is preferably selected from a group of available workflow engines. The workflow engine includes a scheduler for scheduling workflow instance events to be executed by the workflow engine. The virtual workflow operating system also includes a base workflow host that performs transaction, messaging, notification, persistence and tracking functions.

### CROSS-REFERENCE TO RELATED APPLICATION

Pursuant to 35 U.S.C. § 119, this application claims the benefit of the filing date of Provisional Patent Application No. 60/614,096, filed Sep. 29, 2004, titled WORKFLOW IN A COLLABORATIVE APPLICATION, the subject matter of which is also incorporated herein by reference. This application is also related to patent application Ser. No. 11,087,123, filed Mar. 22, 2005, titled WORKFLOW ASSOCIATION IN A COLLABORATIVE APPLICATION, the subject matter of which is also incorporated herein by reference.

### FIELD OF THE INVENTION

The present invention relates to computer software, and more particularly, hosting workflows in a collaborative application.

### BACKGROUND OF THE INVENTION

A collaborative application is an computer software program or interactionable set of computer software programs, i.e., application, that enables a plurality of individuals to more easily collaborate to achieve a particular result, such as the development of a network portal. A workflow is an abstraction of how work flows through a business process. For example, given a business process for approving documents, a workflow may be developed to track a particular document through an approval process as each participant in the approval process receives and approves the document. This abstract notion of a “workflow” has been modeled in computer programs and computer software for supporting workflow through a business process has become known as a “workflow.” Hereinafter, the term “workflow” refers to such a software model, i.e., a software program that supports how work flows through a business process.

Since workflows are computer software programs, workflow development in the prior art has the same problems and limitations of computer software program development. A workflow developed as an individual computer program using a traditional computer programming language may take a long and sometimes unpredictable amount of time to develop, is likely to initially be riddled with defects, and is usually difficult to modify. These disadvantages can be overcome by using workflow authoring tools to develop high level workflow descriptions and executing the high level workflow descriptions on a workflow engine. A workflow engine encapsulates the more difficult to develop but reusable parts of workflows, i.e., the computer instructions that are executed. Workflow authoring tools are used to model a workflow as a set of data structures that the workflow engine uses to execute the workflow. Workflow authoring tools may also be used to generate graphical user interface forms (GUI forms) for a workflow. Such GUI forms include, but are not limited to, forms for routing, approval, document review, document publishing, and issue tracking.

In the prior art, a workflow authored using one set of workflow authoring tools usually cannot be executed on a workflow engine designed to execute workflows authored using a different set of workflow authoring tools. In this sense, a set of workflow authoring tools and the workflow engine that executes workflows authored using the set of workflow authoring tools, are coupled, i.e., comprise a tool-engine couple. There are general purpose tool-engine couples and field specific tool-engine couples. A general purpose tool-engine couple provides features applicable to most workflows. A field specific tool-engine couple provides features applicable to workflows for a particular field of endeavor like finance, insurance, law, medicine, physics, chemistry, biology, and so on.

Certain features provided by a general purpose tool-engine couple may be inapplicable to certain fields of endeavor or may even conflict with requirements of a field of endeavor. Certain features provided by a field specific tool-engine couple may be useful in other fields of endeavor. Using one tool-engine couple restricts workflow authoring and execution to the features provided by the tool-engine couple. There is a need for a way to use the applicable features of a plurality of tool-engine couples while avoiding conflicts from the inapplicable features without resorting to developing workflows as individual computer programs. The present invention is directed to fulfilling this need by using a collaborative application to support a plurality of tool-engine couples, i.e., workflow authoring tools and workflow engines.

### SUMMARY OF THE INVENTION

In accordance with aspects of the present invention, a workflow hosting computing system is provided. The workflow hosting computing system comprises a collaborative application able to support workflow services; workflow services supported by the collaborative application including a virtual workflow operating system and workflow management tools; one or more application programs for communicating with the collaborative application; and one or more programs for deploying and customizing deployed workflows. Preferably, the workflow hosting computing system also includes a compiler for “no code” workflows.

In accordance with one aspect of the invention, the collaborative application is a network portal development and management application.

In accordance with other aspects of the invention, application programs provide a graphical user interface (GUI). Data that describes a workflow state is maintained transactionally consistent between the workflow engine and GUI. The GUI provides forms that enable certain workflow data to be predefined in a workflow definition, the predefined data being used when workflow instances are instantiated and executed. The GUI also provides forms that enable certain workflow data to be predefined in a workflow instance, the predefined data being used when the workflow instances are executed.

In accordance with other further aspects of the invention, the workflow hosting computing system includes a plurality of workflow authoring tools including a highly flexible, minimally automatic authoring tool and a minimally flexible, highly automatic authoring tool that is a “no code” workflow design tool. The workflow engine is selected from a group of available workflow engines. The workflow services also includes workflow management tools. The workflow management tools include a reporting tool. The workflow engine includes a scheduler for scheduling workflow instance events to be executed by the workflow engine. The virtual workflow operating system also includes a base workflow host that performs transaction, messaging, notification, persistence and tracking functions.

As will be readily appreciated from the foregoing summary, the present invention is directed to a workflow hosting computer system, comprising workflow support services within a collaborative application, that supports a plurality of workflow authoring tools and a workflow engine selected from a plurality of available workflow engines.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exemplary block diagram of workflow hosting in a collaborative application computing system that includes workflow authoring tools and a workflow engine;

FIG. 2 is a block diagram showing the functional relationships between client applications in an exemplary collaborative application environment;

FIG. 3 is a block diagram showing how messages are sent to an exemplary workflow instance; and

FIG. 4 is a block diagram showing how workflow data is promoted to data that may be accessed directly by a collaborative application.

### DETAILED DESCRIPTION OF THE PREFERRED EMBODIMENT

The invention is directed to providing workflow hosting in a collaborative application computing system. The workflow hosting includes workflow support services that support a plurality of workflow authoring tools and a workflow engine. The workflow engine may be selected from a plurality of workflow engines. A workflow processes information about a business process such as information about: (a) the procedural steps of the business process; (b) the persons involved in each step of the business process; (c) the input and output required at each step of the business process; and (d) the tools needed at each step of the business process. As those skilled in the art will readily appreciate, a workflow may process other types of information in addition to the aforementioned exemplary types of information. A workflow is described by a workflow definition comprising workflow state, metadata, and possibly other data structures. A workflow instance is generated by instantiating a workflow definition. “Instantiating” is the process of generating an instance of a workflow from a workflow definition. An instance of a workflow is a data structure or set of data structures describing a workflow. A workflow instance is executed by a workflow engine.

The humans which interact with a workflow definition or workflow instance are referred to by their roles in relation to the workflow definition or workflow instance: (a) owner, the person who creates and controls a workflow instance; (b) developer, a person who designs and implements all or parts of a workflow definition and/or workflow components; and (c) participant, a person who participates in one or more activities controlled by a workflow instance. Activities include, but are not limited to, review, revision, and approval. Obviously, the rules may overlap. For example, the owner may also be a developer and/or a participant. An entity that responds to input from a workflow instance is an actor. An actor may be a participant or a computing device. Preferably, human actors interact with workflow instances using graphical user interface forms (GUI forms). A GUI form may be a window in an application, a Web page, or like graphical user interface component that enables human actors to view, select, and/or enter information.

An example of a collaborative application computer system suitable for supporting the authoring and execution of workflows is the Windows SharePoint portal server (SharePoint), which provides Windows SharePoint Services, i.e., WSS. SharePoint provides services suitable for developing, deploying, and maintaining collaborative applications, namely, information portals. An information portal is a collaborative application that includes a collection of related information sites organized to provide centralized, unified, and coordinated access to the information in the sites. The information portal information is often viewed with a Web browser. A Web browser is a software program that interprets Web page description files such as files written in Hypertext Markup Language (HTML), generates Web pages from the descriptions, and displays the Web pages. Normally, in order to be useful, an information portal, including the information portal sites, exist on a network such as the World Wide Web or an intranet. Strictly speaking, a collaborative application computer system that supports the authoring and execution of workflows does not need to exist on a network to be useful. A collaborative application computer system that supports the authoring and execution of workflows could be implemented on a single computing device with each participant using a Web browser running on the computing device to complete their assigned workflow tasks.

A collaborative application computer system suitable for supporting the authoring and execution of workflows preferably includes lists, documents, and document libraries. In a Windows SharePoint Services or SharePoint Portal Server, a list is a Web site component that enables a Web site user to store and display information using a Web browser. Lists and documents are similar in that both are able to store tabular data. A document is a self-contained piece of work created with an application program that may be saved as a file and given a unique filename by which the document can be retrieved. A document library is a collection of documents that are shared in Web sites based on Microsoft SharePoint Products and Technologies. For example, a document library may contain the graphics used in a project. Document libraries may be viewed using a Web browser. In addition to the documents themselves, a document library contains metadata, i.e., information about each of the documents. When a document is added to a document library, metadata about the document is also added. The metadata is similar for each document in a document library. For example, if a document library contains product plans, the metadata associated with each document in the document library may include the title, comments about the content of the document, and the document's status. Metadata may be viewed, along with other information associated with a document library, using a Web browser. To ensure that all documents within a document library have a consistent look and feel, a template may be specified and associated with the document library. A template is one or more files that contain the structure and tools for shaping such elements as the style and page layout of a finished document. For example, a Microsoft Word template can be used create the particular kind of document stored in a document library.

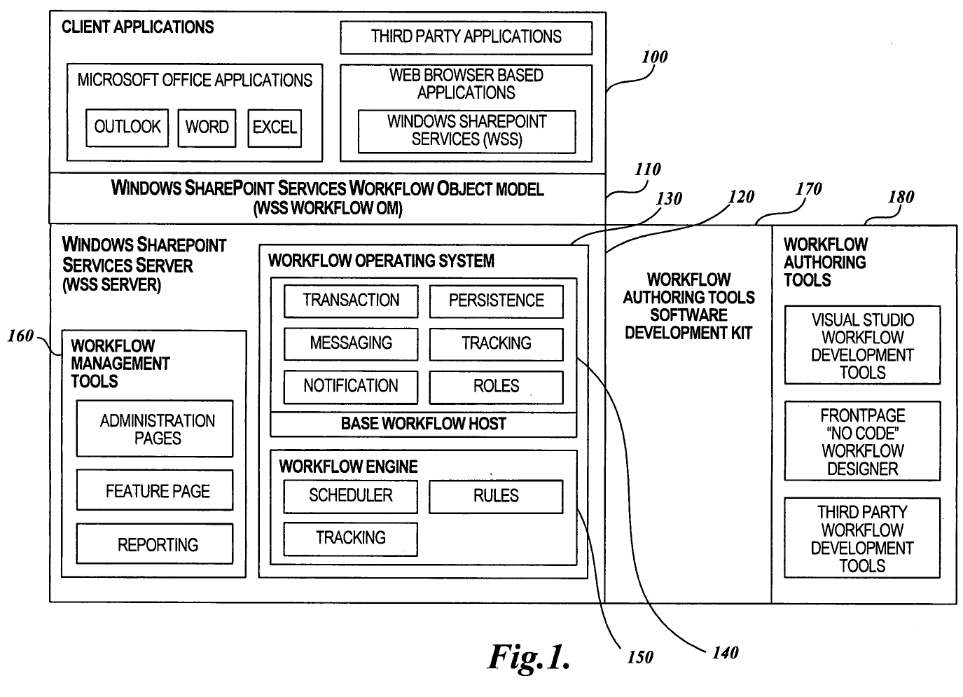

A computing environment is a configuration of computing resources, including hardware and/or software, directed to a common purpose. A workflow environment is a collaborative application computing environment directed to the authoring and execution of workflows. FIG. 1 is an exemplary block diagram of workflow hosting in a collaborative application computing system. The major components, i.e., computing resources, of the exemplary workflow hosting in a collaborative application computing system shown in FIG. 1 are client applications 100, a Windows SharePoint Services Workflow Object Model (WSS Workflow OM) 110, a Windows SharePoint Services Server (WSS Server) 120, a workflow authoring tools software development kit 170, and workflow authoring tools 180.

When appropriately configured, the WSS Server 120 forms an exemplary embodiment of the invention, i.e., a collaborative application computing system that supports, i.e., hosts, the authoring and execution of workflows. Client applications 100 include, but are not limited to, Microsoft Outlook, Word, Excel, applications developed by third parties, and web based browser applications like Windows SharePoint Services (WSS). Client applications 100 use a Web service that packages the Windows SharePoint Services Workflow Object Model (WSS Workflow OM) 110 to interact with the Windows SharePoint Services Server (WSS Server) 120. The WSS Workflow OM 110 comprises the application programming interface (API) and the data structures used by, accepted by, and/or returned by functions in the API.

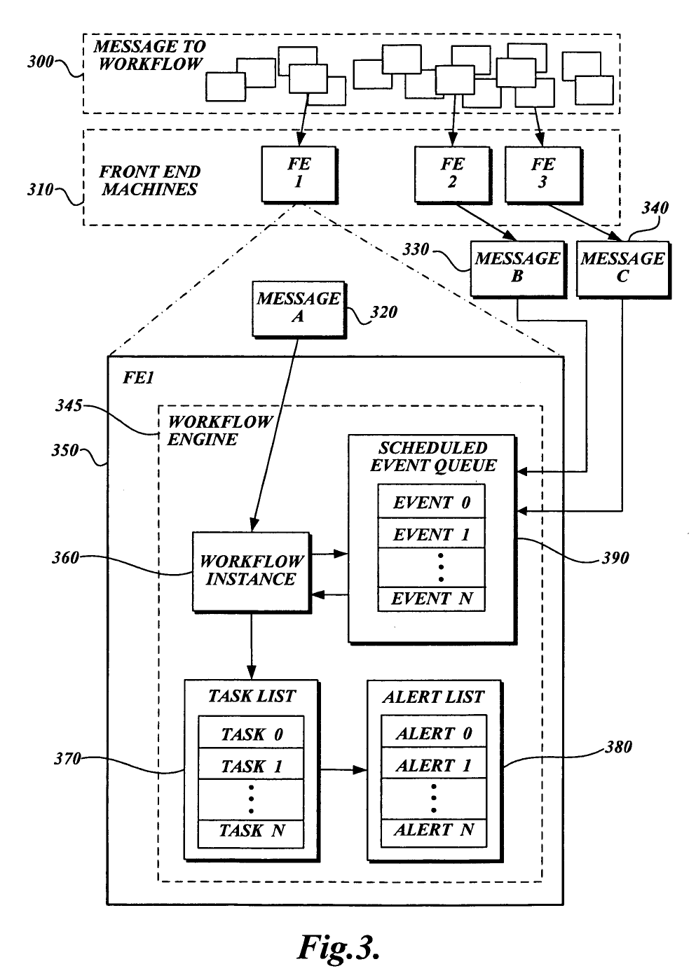

The WSS Server 120 includes a workflow operating system 130. Those skilled in the art will appreciate that the workflow operating system 130 is virtual in that it provides the functions of an operating system, but is not connected directly to hardware as is a true operating system. The workflow operating system 130 comprises a base workflow host 140 and a workflow engine 150. The base workflow host 140 provides workflow related services that include, but are not limited to, transaction, messaging, notification, persistence, tracking, and roles. The workflow engine 150 comprises scheduler, rules, and tracking components. While a single workflow engine is illustrated in FIG. 1, as will be better appreciated from the following description of FIG. 3, multiple workflow engines may be available for selection by the virtual workflow operating system 130. The WSS Server 120 also provides support for workflow management tools 160 including, but not limited to, administration pages, a feature page, and reporting services.

The workflow authoring software development kit 170 provides a way for workflow authoring tool developers to develop workflow authoring tools 180 that operate on workflows running within the workflow operating system 130. Types of workflow authoring tools 180 include, but are not limited to, Microsoft Visual Studio Workflow Development Tools (Microsoft Visual Studio), Microsoft FrontPage “no code” Workflow Designer (Microsoft FrontPage), and third party workflow development tools. Microsoft Visual Studio is the most flexible tool to author workflows, but the least automatic. Microsoft FrontPage is more automatic, but less flexible than Microsoft Visual Studio because Microsoft FrontPage enables workflow development without resorting to writing computer instructions, i.e., “no code” design. Microsoft FrontPage enables authoring a workflow from prepackaged workflow activity code and packaging and applying the workflow automatically. However, a workflow developed using Microsoft FrontPage must be sequential, i.e., an activity in the workflow must be completed before the next activity is made available to the participants.

The exemplary workflow environment shown in FIG. 1 and described above provides a workflow operating system 130 and workflow management tools 160 as services within WSS Server 120. Note that parts of the exemplary workflow environment exist inside of WSS Server 120, e.g., the workflow operating system 140, and parts of the workflow environment exist outside of, but communicate with, the WSS Server 120, e.g., the workflow authoring tools 180. The WSS Workflow OM 110 provides the interface between the client applications 100 and the WSS Server 120.

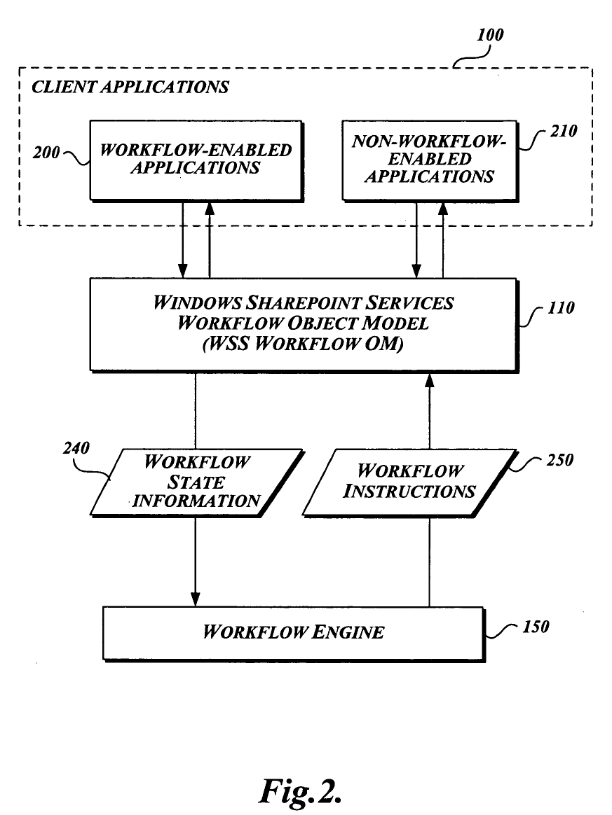

FIG. 2 is a block diagram showing the functional relationship between the WSS Workflow OM 110 and the client applications 100, and the functional relationship between the WSS Workflow OM 110 and the workflow engine 150. In FIG. 2, client applications 100 are categorized as workflow-enabled applications 200 and non-workflow-enabled applications 210. Both workflow-enabled applications 200 and non-workflow-enabled applications 210 are able to generate documents, i.e., files that can be associated with and manipulated by a workflow instance. Workflow-enabled applications 200 also contain functions designed to interact with workflow instances, e.g., invoke a form to complete a workflow task. Client applications 100 interact with the workflow engine 150 through the interface provided by the WSS workflow OM 110. Client applications 100 pass workflow state information 240 to the workflow engine 150. The workflow engine 150 passes workflow instructions 250 to the client applications 100.

The workflow engine 150 responds to workflow state information 240 by instantiating workflow definitions and operating on workflow instances. A workflow instance is stored in memory when a workflow instance is active and stored in a database when a workflow instance is inactive. The workflow engine 150 delivers events to a workflow instance when the workflow instance is active or inactive. Note that a workflow instance interacts only with the workflow engine 150 and the workflow engine 150 interacts with the WSS Server 120.

The owner of a workflow instance uses a GUI form to place documents “in” the workflow instance. A document that is “in” the workflow instance is acted on by the workflow instance but is not part of, i.e., not contained by, the workflow instance. Participants of the workflow instance use GUI forms to apply actions to documents in the workflow instance. If a list item, e.g., a document, has an attachment and the list item is in a workflow instance, the attachment is also in the workflow instance. Only individual items can be in a workflow instance. If a workflow is associated with a document library, the workflow instance is made available to particular items in the document library but the document library is not in the workflow.

Multiple workflow templates can be associated with a list or library, but in the exemplary embodiment of the invention described herein one and only one workflow instance of a workflow association can be running on an item in the library at one time. For example, a list of contracts can have a Contract Review workflow template and a Contract Signing workflow template associated with the list of contracts. A contract can have at most one Contract Review instance and one Contract Signing instance running simultaneously. A workflow instance's execution need not be strictly linear. A workflow instance can have multiple activities running simultaneously across a workflow instance.

Metadata that describes one or more aspects of a list or document library can be abstracted from the list or document library and placed into a data structure referred to as a “content type.” In an exemplary embodiment of the invention, a content type is expressed in XML. A content type may be expressed in other declarative languages hence, the use of XML to express a content type should be construed as exemplary and not limiting upon the invention. Content types enable the reuse of metadata that describes aspects of lists or document libraries. After a content type is defined, the content type can be used to define other content types. Content types can be “added to” lists and document libraries. If a content type is added to a list or document library, the metadata defined in the content type is copied to the list or document library causing the metadata to be applied to items of the content type in the list or document library. A content type can also be “pushed down” a list or document library that has had the content type added. If a content type is pushed down a list or document library, the metadata defined in the content type is updated for all items of the content type in the list or document library. Workflow associations are a type of metadata that can be added to a content type. If the content type contains workflow functions, those workflow functions can be applied to the document. For example, if an “approval” workflow function is associated, i.e., added to an “approval” content type and the approval content type is subsequently added to or pushed down to a document library, a document in the document library of the approval content type will have the approval workflow function available.

A developer creates a workflow definition and hands the definition off to a WSS machine administrator; the machine administrator causes the workflow definition to be deployed to the machine; a site collection administrator causes the workflow definition to be made available to users of a site collection; a site owner associates a workflow with a list or document library; a workflow initiator creates an instance of a workflow and starts the workflow; and one or more participants interact with the workflow instance. For example, a developer designs a GUI form for workflow association with lists and document libraries as one aspect of creating a new workflow definition for a business process such as approving a document. The GUI form assigns a default routing to the workflow definition. The GUI form is used for routing and to add states, transitions, events, and possibly scripts to the workflow definition. A workflow state defines a specific condition in the workflow. Exemplary states include, but are not limited to, Active, Resolved, or Closed. Transitions define changes between two states, for example, a change from the Active state to the Closed state. Events trigger transitions. Exemplary events include, but are not limited to, Enter, Create, Delete, Change, Receive, Exit, and Expire. For example, an Expire event might trigger a transition from the Active state to the Closed state. Scripts are small programs that execute more than one event or do other work in addition to events.

The exemplary GUI form used to create a new workflow definition may also be used to predefine certain workflow data so that the predefined workflow data is used when the workflow is instantiated, deployed, and activated. For example, the exemplary GUI form may be used to predefine a required document approver. The predefined approver is made available in other GUI forms used instantiate and modify a workflow defined by the workflow definition. With the new workflow definition now available in the database, an owner uses another exemplary GUI form to select the workflow definition and instantiate a workflow instance from the workflow definition. As with the GUI form used to create the workflow definition, the GUI form used to instantiate the workflow may also be used to predefine certain workflow data so that the predefined data is used when the workflow is deployed and activated. For example, the GUI form used to instantiate the workflow may be used to predefine the due date of the review workflow tasks.

A GUI form sends a message to the WSS Server 120 to request that WSS Server 120 instantiate a workflow instance from the workflow definition. The WSS Server 120 receives the message to instantiate the workflow instance from the workflow definition. WSS Server 120 creates a workflow instance in memory. When first instantiated, the workflow instance is empty and in an empty state, i.e., contains no data or state information. The workflow may be designed such that a task is generated automatically after the workflow is instantiated so that a participant receives the workflow task. The task is created with workflow and item/document IDs that can be used for future correlation of the task to the workflow instance or item at a future time. After creating the initial tasks, the workflow may not have any additional work to do until user input is received, so the workflow instance may go “idle” and the host may choose to persist the workflow instance's state to the database in order to free up memory.

Typically, a workflow task involves entering information in a GUI form. The participant enters information, e.g., task parameter values, in one or more GUI forms. The information from the GUI form or forms is collected and associated with an appropriate transaction ID. The transaction is sent to workflow engine 150 and processed by the workflow engine 150 for the workflow instance. The workflow engine 150 receives workflow state information for each workflow instance executing within the workflow engine 150. The workflow engine 150 uses the workflow state information for a workflow instance to advance the workflow instance through the states in the workflow instance. An event is received by the workflow engine 150. Using the workflow instance ID, the workflow engine 150 applies the event to the appropriate workflow instance. The event may trigger a transition in the workflow instance from one state to the next state. Some events do not trigger a transition change and are essentially ignored by the workflow.

FIG. 3 shows how messages 300 are sent to an exemplary workflow instance 360 being executed by a workflow engine 345. In order to focus more easily on the workflow instance 360, the WSS Server in which the workflow operating system and workflow engine operate is not shown. Messages intended for a workflow 300, possibly from somewhere on a network, are sent to the front-end machines 310 of a Web site farm. A Web site farm is a collection of computers coordinated to operate as one Web site. A front-end machine is a computer in a Web site farm configured to accept external messages and distribute the messages to server computers within the Web site farm configured to respond appropriately to specific kinds of messages. To reduce the complexity of directing messages to embodiments of the present invention, a workflow instance is allowed to run on one, and only one, front-end machine. Although a workflow instance is allowed to run on one, and only one, front-end machine at a time, each front-end machine contains a workflow environment including a workflow engine. A workflow instance may be moved from one front-end machine to another. If a workflow instance is locked in a database on a given front-end machine, it is likely that the workflow instance is running on another front-end machine. Therefore, messages intended for the workflow instance are passed to the front-end machine running the workflow instance.

In the situation where a message is passed directly to the front-end machine running a exemplary workflow environment, the message intended for the workflow 300 is sent to the front-end machines 310 of the Web farm. The message, i.e., Message A, is directed to the front-end machine, i.e., FE1 350, running an embodiment of the invention. Message A is passed to the workflow instance 360. The workflow instance 360 converts Message A into a task, e.g., Task 1, and adds Task 1 to the task list 370 of the workflow instance. When the scheduler in the workflow engine 150 determines that the Task 1 is ready to be worked on by a participant, the workflow engine 150 posts an alert, e.g., Alert 1, in the alert list 380. When the scheduler determines that an alert is due, the scheduler causes the workflow engine 150 to post an event to send a message to the appropriate participants.

In the situation where a message is passed to a front-end machine that is not running an embodiment of the invention, the message intended for the workflow 300 is sent to the front-end machines 310 of the Web farm. The message, i.e., Message B, is directed to a front-end machine, i.e., FE2. Because the front-end machine FE2 is not running an embodiment of the invention, Message B is posted as an event in the scheduled event queue 390. The workflow engine 150 pulls events from the scheduled event queue 390 in FIFO order. An event from the scheduled event queue 390 is processed by the workflow instance 360 in the same way as Message A described above. Before a workflow instance 360 enters an idle state, the workflow instance 360 may check the scheduled event queue 390 for events to execute.

In an embodiment of the invention, batch processing of events in the scheduled event queue 390 is provided by WSS Server 160. A fail over mechanism for the task list 370, alert list 380, and the scheduled event queue 390 based on machine GUID (globally unique identifier), process ID, and timestamp is also provided.

The activities of the workflow operating system 130 involve transactions with one or more databases. As shown in FIG. 1, the base workflow host 140 provides a transaction service by relying on the transaction functions in WSS Server 120. Since the transaction service requires a public interface in order to operate, the transaction service provides secure transactions by using a GUID tracking ID to protect the private data that is accessed with the public interface.

In order to maintain an acceptable level of performance, the base workflow host 140 uses lighter weight versions of the types of transactions available in WSS Server 120. Lighter weight transactions sacrifice transactional consistency for performance. To be transactionally consistent, all statements within a transactions must complete successfully or, if all statements do not complete successfully, all statements are rolled back, i.e., the data set involved in the transaction is returned to the state of the data set before the transaction was initiated. In a workflow, it is important for the data presented in the GUI to be transactionally consistent with the data representing the workflow. To compensate for the effect of having to use the lighter weight transactions available in WSS Server 120, an embodiment of the invention uses the Recycle Bin, a software component of WSS Server 120. The Recycle Bin is a software component into which data items may be moved before the memory for the data items is released for reuse, i.e., recycled. A useful characteristic of the Recycle Bin is that the data items within it are handled in a transactionally consistent manner. An exemplary workflow environment may move a transaction into the Recycle Bin to take advantage of this characteristic and provide transactional consistency for the transaction.

The workflow operating system 130 must often store a workflow instance 360 persistently, i.e., on a nonvolatile storage medium. As shown in FIG. 1, the base workflow host 140 provides a persistence service based on storage services available in WSS Server 120. Among the features of the storage services provided by WSS Server 120 and used by the workflow operating system 130, are hydration, dehydration, and hibernation. Dehydration is a type of storage process designed to minimize the amount of persistent storage required for a given item in memory, i.e., a workflow instance 360. Hydration is the inverse of dehydration, i.e., a process in which a dehydrated workflow instance 360 is restored into memory. Workflow instance hibernation is a state in which a workflow instance schedule consumes no computing resources other than the static storage persistent in a database. Hibernation reduces the amount of computer resources consumed by dehydrated workflow instances.

When a workflow instance 360 is hydrated and active, the workflow instance 360 is locked. When a workflow instance 360 is inactive, i.e., in an idle state, and dehydrated, the workflow instance 360 is unlocked. The dehydrated workflow instance 360 waits for a message from the task list 370 to hydrate and start running again. The workflow instance 360 determines whether or not to enter an idle state. If a workflow instance 360 enters an idle state, the workflow instance 360 sends an event to the workflow engine 150 informing the workflow engine 150 that the workflow instance 360 is in an idle state. The workflow engine 150 then dehydrates the workflow instance 360.

A workflow flow instance 360 may enter an idle state at points explicitly defined in the workflow schedule by the workflow developer, or at points of acquiescence. A point of acquiescence is a point at which the workflow instance enters a state of acquiescence, i.e., a period of time in which no useful work or interaction happens. In essence, the workflow instance is waiting for a potentially long and indeterminate amount of time for something to happen. When such a condition is detected, the workflow instance sets a transaction point. At a transaction point, a workflow instance collects data describing the internal state of the workflow and persistently stores the internal state data with the corresponding schedule in a database. Along with this transaction, other schema management may also occur. At a transaction point, a workflow instance may be put into a state of hibernation. For example, if there are no events in the scheduled event queue 390, the workflow instance's exclusive lock is released, the workflow instance is dehydrated, and the workflow instance is allowed to go into hibernation. Preferably, an active process continually monitors the scheduled event queue looking for events that need to have the workflows on them woken up. Once such a workflow instance has been identified, a suitable machine is designated as a host for the workflow instance, and the workflow instance is hydrated, i.e., the binary code and state information for the workflow instance are loaded from persistent storage onto the host machine. The workflow instance is bootstrapped into a running state.

The activities of the workflow operating system 130 rely on messages sent to, from, and within the workflow operating system 130. As shown in FIG. 1, the base workflow host 140 provides a messaging service by relying on the messaging functions in WSS Server 120.

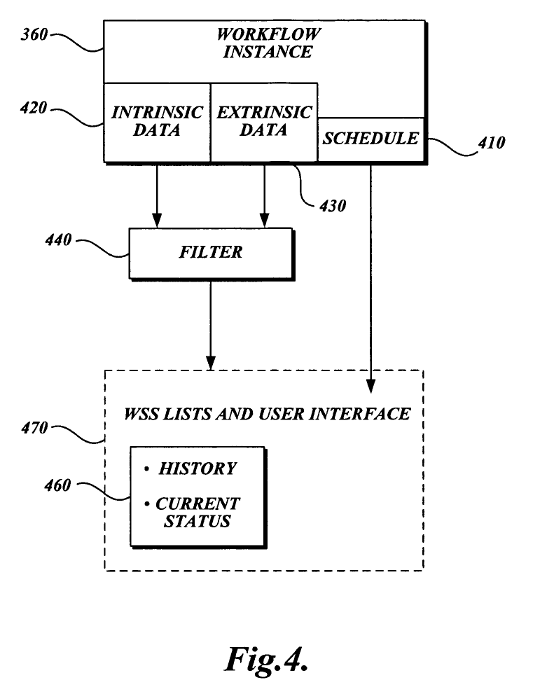

As also shown in FIG. 1, workflow management tools 160 include reporting tools to enable owners to determine, for example, how much time it took a workflow instance 360 to be completed and where the time was spent in order to locate bottlenecks in a workflow. To provide such information to the reporting tools, certain activities in a workflow instance 360, i.e., intrinsic data, may need to be audited, or a certain external state, i.e., extrinsic data, may need to be exported from the workflow instance. Data within a workflow instance 360 is arranged into the types of columns and tabular data that applications within WSS Server 120 are able to use, i.e., a SharePoint list. For example, to make data within a workflow instance accessible to the workflow management tools 160 within WSS Server 120, the data must be promoted, i.e., converted into a SharePoint list. The block diagram in FIG. 4 shows how data within a workflow instance is promoted into a SharePoint list. The workflow instance 360 contains intrinsic data 420, extrinsic data 430, and a schedule 410. The intrinsic data 420 and extrinsic data 430 is passed through a filter 440. The filtered data, i.e., a SharePoint list, is passed to SharePoint, i.e., WSS Server 120, where the SharePoint list may be used, for example, to create a report 460 containing information about the history and current status of the workflow instance 400. Information about a schedule 410 is not filtered, but passed directly to WSS Server 120.

As will be readily appreciated by those skilled in the art and others, embodiments of the invention provide workflow hosting in a collaborative application computing system. The workflow hosting includes workflow support services that support a plurality of workflow authoring tools and a workflow engine. The workflow engine may be selected from a plurality of workflow engines. While the preferred embodiment of the invention has been illustrated and described, it will be appreciated that various changes can be made therein without departing from the spirit and scope of the invention as defined by the appended claims. For example, actual embodiments of the invention may use additional and/or different workflow management tools 160 without departing from the spirit and scope of the invention.

The embodiments of the invention in which an exclusive property or privilege is claimed are defined as follows:

1. A workflow hosting computing system comprising:
a collaborative application able to support workflow services;
workflow services including a virtual workflow operating system and workflow management tools, said workflow operating system including a workflow engine for instantiating and executing workflow instances;
at least one application program for communicating with said collaborative application; and
at least one workflow authoring tool for creating a workflow including workflow instances suitable for instantiation and execution by said workflow engine.

2. The workflow hosting computing system claimed in claim 1 wherein the collaborative application is a network portal development and management application.

3. The workflow hosting computing system claimed in claim 1 wherein said at least one application program provides a graphical user interface (GUI) and wherein data that describes a workflow state is maintained transactionally consistent by said computing system between said workflow engine and said GUI.

4. The workflow hosting computing system claimed in claim 1 wherein said application program provides a graphical user interface (GUI) and wherein said GUI provides forms that enable certain workflow data to be predefined in a workflow definition, said predefined data being used when said workflow instances are instantiated and executed.

5. The workflow hosting computing system claimed in claim 4 wherein said application program provides a graphical user interface (GUI) and wherein said GUI provides forms that enable certain workflow data to be predefined in a workflow instance, said predefined data being used when said workflow instances are executed.

6. The workflow hosting computing system claimed in claim 1 including providing batch processing of scheduled workflow events in workflow event queues.

7. The workflow hosting computing system claimed in claim 1 including a plurality of workflow authoring tools.

8. The workflow hosting computing system claimed in claim 7 wherein one of said plurality of workflow authoring tools is a highly flexible, minimally automatic authoring tool and another of said plurality of workflow authoring tools is a minimally flexible, highly automatic authoring tool.

9. The workflow hosting computing system claimed in claim 8 wherein said one authoring tool is a “no code” workflow design tool.

10. The workflow hosting computing system of claim 1 wherein said workflow engine is selected from a group of available workflow engines.

11. The workflow hosting computing system of claim 1 wherein said workflow services also includes workflow management tools.

12. The workflow hosting computing system of claim 11 wherein said workflow management tools include a reporting tool.

13. The workflow hosting computing system of claim 1 wherein said workflow engine includes a scheduler for scheduling workflow instance events to be executed by said workflow engine.

14. The workflow hosting computing system of claim 1 wherein said virtual workflow operating system also includes a base workflow host.

15. The workflow hosting computing system of claim 14 wherein said base workflow host performs transaction, messaging, notification, persistence and tracking functions.
